(19) United States
(12) Patent Application Publication
(10) Pub. No.: US 2006/0214970 A1
(43) Pub. Date: Sep. 28, 2006

(54) Image forming apparatus and method

(75) Inventor: Takashi Hirakawa, Ashigara-Kami-Gun (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/386,671

(22) Filed: Mar. 23, 2006

(30) Foreign Application Priority Data
Mar. 25, 2005 (JP) 2005-089555

(51) Int. Cl. B41J 2/205

(52) U.S. Cl. 347/15; 347/100

(57) ABSTRACT

The image forming apparatus comprises: a first liquid deposition device which deposits a first liquid onto a recording medium; and an ejection head which ejects a second liquid onto the first liquid deposited on the recording medium by the first liquid deposition device, wherein a contact angle of the first liquid with respect to the recording medium is not less than 60°, and a contact angle of a mixed liquid of the first liquid and the second liquid with respect to the recording medium is not less than 60°.

### BACKGROUND OF THE INVENTION

1. Field of the Invention

The present invention relates to an image forming apparatus and method, and more particularly to an inkjet recording apparatus or other image forming apparatus, and an image forming method, whereby high-quality images are formed by improving the fixing characteristics of ink by combining two types of liquids on a recording medium.

2. Description of the Related Art

Japanese Patent Application Publication No. 2004-10833 discloses an ink set for inkjet recording comprising ink and a liquid constituent having the action of causing the ink to aggregate, which is excellent in terms of optical density, bleeding, color mixing, and drying time. More specifically, it is proposed that the ratio of the surface tension (mN/m) with respect to the viscosity (mPa·s) of the ink be between 5 and 30 inclusive, that the ratio of the surface tension (mN/m) with respect to the viscosity (mPa·s) of the liquid constituent be between 5 and 40 inclusive, and that the initial contact angle of the ink on the recording medium be 75 degrees or above.

Furthermore, Japanese Patent Application Publication No. 11-11000 discloses an inkjet recording method and inkjet recording apparatus whereby excellent uniformity of color and clear image appearance are obtained, particularly when recording on normal paper using ink and a recording properties enhancing liquid which causes the coloring material of the ink to become insoluble. More specifically, it is proposed that the surface tension γ1 of the ink and the surface tension γ2 of the recording properties enhancing liquid be, respectively, 30 dyn/cm<γ1≦40 dyn/cm, and 30 dyn/cm<γ2≦40 dyn/cm, and that the application rate of the recording properties enhancing liquid be less than one with respect to the ink.

Japanese Patent Application Publication No. 2000-218772 discloses an inkjet recording apparatus which is capable of obtaining high-quality images by suppressing bleeding and feathering by using a treatment liquid that causes the coloring material in an ink to become insoluble or to aggregate. More specifically, Japanese Patent Application Publication No. 2000-218772 discloses technology which increases the permeability of the solvent apart from the coloring material, when the two liquids are combined, by reducing the surface tension of the treatment liquid, while also preventing bleeding of the ink by increasing the surface tension of the ink, and which prevents feathering between colors by raising the fixing properties of the mixture generated by the two liquids. Under proposed specific conditions, the surface tension of the treatment liquid including cationic material is 25 to 30 dyn/cm and the surface tension of the ink containing a dye containing anionic material is 33 to 45 dyn/cm.

However, Japanese Patent Application Publication No. 2004-10833 does not specify the contact angle of the liquid constituent which has an action of causing the ink to aggregate. If the contact angle of the liquid constituent becomes smaller, then the permeation of the liquid constituent into the recording medium is accelerated due to the increased speed of permeation into the recording medium, and hence phenomena, such as bleeding of ink on the recording medium due to the failure of the ink to react with the liquid constituent on the recording medium, may occur.

Furthermore, in Japanese Patent Application Publication No. 11-11000, the contact angle is not specified, and therefore it is difficult to suppress bleeding of the ink on the recording medium. More specifically, it is necessary to consider the contact angle, in addition to the surface tension of the ink and the recording properties enhancing liquid. For example, even if the surface tension is the same, the contact angle varies with the type of surface-active agent used, and if the contact angle becomes smaller, then the speed of permeation of the ink into the recording medium becomes faster and the ink permeates more rapidly into the recording medium.

In Japanese Patent Application Publication No. 2000-218772, the permeation of the treatment liquid becomes faster due to the low surface tension of the specified treatment liquid, and hence the treatment liquid and the ink are not able to react on the recording medium.

### SUMMARY OF THE INVENTION

The present invention has been contrived in view of the foregoing circumstances, an object thereof being to provide an image forming apparatus and an image forming method whereby bleeding of the dots formed on the recording medium is suppressed, and high-quality images can be formed.

In order to attain the aforementioned object, the present invention is directed to an image forming apparatus, comprising: a first liquid deposition device which deposits a first liquid onto a recording medium; and an ejection head which ejects a second liquid onto the first liquid deposited on the recording medium by the first liquid deposition device, wherein a contact angle of the first liquid with respect to the recording medium is not less than 60°, and a contact angle of a mixed liquid of the first liquid and the second liquid with respect to the recording medium is not less than 60°.

According to the present invention, the first liquid is deposited onto the recording medium by means of the first liquid deposition device, and the second liquid is deposited onto the first liquid by ejecting the second liquid from the ejection head, in a state where the first liquid is present on the recording medium. In this case, by setting the contact angle of the first liquid with respect to the recording medium to be 60° or greater, it is possible to reduce the permeation speed of the first liquid into the recording medium (to slow down permeation), and therefore a reliable reaction can be achieved on the recording medium between the first liquid and the second liquid which is ejected in the form of droplets onto the recording medium where the first liquid has been deposited. Furthermore, by setting the contact angle of the mixed liquid of the first and second liquids, with respect to the recording medium, to be 60° or greater, the permeation speed of the mixed liquid is slowed and sufficient time for reliably ensuring reaction between the first liquid and the second liquid is guaranteed, in addition to which, the permeation of the mixed liquid into the recording medium is suppressed and desirable dots which do not produce visible bleeding and which have the prescribed density are formed.

Desirably, the deposition onto the recording medium of at least the second liquid (in other words, the ejection from the ejection head) is controlled on the basis of the image data for printing. The mode of the first liquid application device is, for example, a device which ejects the first liquid in the form of liquid droplets by means of an inkjet type of ejection head, a device which applies the first liquid by means of an application member such as a roller, brush, a blade-shaped member and a porous member, a device which deposits the first liquid by spraying a mist, or a suitable combination of these devices.

In the case of a composition in which the first liquid is deposited by using an ejection head, it is possible to deposit the first liquid selectively, only in the printing locations on the recording medium, on the basis of the image data, and therefore, the consumption of the first liquid is reduced in comparison with an application device, such as a roller.

On the other hand, a device which applies the first liquid by placing an application member, such as a roller, in contact with the recording medium has a merit in that it enables handling of a liquid of high viscosity of a type which is difficult to eject in an inkjet type ejection head.

The “recording medium” in the image forming apparatus according to the present invention indicates a medium on which an image is recorded by means of liquid (recording body) ejected from the ejection head (this medium may also be called a recording medium, print medium, image forming medium, ejection receiving medium, image receiving medium, or the like). This term includes various types of media, irrespective of material and size, such as continuous paper, cut paper, sealed paper, resin sheets, such as OHP sheets, film, cloth, a printed circuit board on which a wiring pattern, or the like, is formed by means of a liquid droplet ejection head, and an intermediate transfer medium, and the like.

Preferably, a contact angle of the second liquid with respect to the recording medium is not less than 60°.

By setting the contact angle of the second liquid with respect to the recording medium to be 60° or greater, it is possible reliably to achieve an angle of 60° or greater for the contact angle of the mixed liquid of the first liquid and the second liquid with respect to the recording medium. Furthermore, even in a case where the second liquid lands on portions of the recording medium where the first liquid has not been deposited, it is still possible to slow the permeation speed of the second liquid with respect to the recording medium, thereby obtaining dots which produce little bleeding.

Preferably, a surface tension of the first liquid is lower than a surface tension of the second liquid.

When the second liquid lands on the recording medium on which the first liquid has been deposited, the first liquid readily covers the second liquid, and hence the reaction in the region where the first liquid and the second liquid make contact is promoted, and spreading of the dots of the second liquid can be suppressed.

Preferably, the first liquid contains a cationic surface-active agent, and a surface tension of the first liquid is not less than 30 mN/m and not more than 40 mN/m.

If the cationic surface-active agent is used as the surface-active agent, then by setting the surface tension of the first liquid so as to be 30 through 40 mN/m, it is possible to slow the permeation speed of the first liquid, and hence the first liquid and the second liquid can be made to react together in a reliable fashion.

Alternatively, it is also preferable that the first liquid contains a nonionic surface-active agent, and a surface tension of the first liquid is not less than 34 mN/m and not more than 40 mN/m.

If the nonionic surface-active agent is used as the surface-active agent, then by setting the surface tension of the first liquid so as to be 34 through 40 mN/m, it is possible to slow the permeation speed of the first liquid, and hence the first liquid and the second liquid can be made to react together in a reliable fashion.

Preferably, a surface tension of the second liquid is not less than 35 mN/m and not more than 50 mN/m.

By setting the surface tension of the second liquid so as be 35 through 50 mN/m, spreading of the second liquid when the second liquid lands on the first liquid is suppressed.

Preferably, the second liquid is an ink containing a coloring material; and the first liquid is a treatment liquid containing a substance which causes insolubilization and aggregation of the coloring material in the second liquid deposited on the first liquid.

When the second liquid makes contact with the first liquid, the coloring material contained in the second liquid becomes insoluble due to a reaction between the two liquids, and permeation of the second liquid into the recording medium is suppressed. In this way, the coloring material (reacted aggregate) collects in the vicinity of the surface of the recording medium, thereby achieving high-density coloration, and hence an image of high quality can be formed.

By providing a liquid removal device which removes the liquid (solvent) remaining on the recording medium, at a position downstream of the liquid ejection head, then it is possible to prevent cockling from occurring in the recording medium. This liquid removal device may be a drying device which dries the recording medium by blowing a heated airflow onto same, or a liquid absorbing member which absorbs the liquid by placing an absorbing member, such as a nonwoven cloth, porous member, or the like, in contact with the recording medium.

A compositional embodiment of an ejection head in the image forming apparatus according to the present invention is a full line type inkjet head having a nozzle row in which a plurality of nozzles are arranged through a length corresponding to the full width of the recording medium.

In this case, a mode may be adopted in which a plurality of relatively short ejection head blocks having nozzles rows which do not reach a length corresponding to the full width of the recording medium are combined and joined together, thereby forming nozzle rows of a length that correspond to the full width of the recording medium.

A full line type inkjet head is usually disposed in a direction that is perpendicular to the relative feed direction (relative conveyance direction) of the recording medium, but a mode may also be adopted in which the inkjet head is disposed following an oblique direction that forms a prescribed angle with respect to the direction perpendicular to the conveyance direction.

The movement device for causing the recording medium and the ejection head to move relatively to each other may include a mode where the recording medium is conveyed with respect to a stationary (fixed) head, or a mode where a head is moved with respect to a stationary recording medium, or a mode where both the head and the recording medium are moved.

In order to attain the aforementioned object, the present invention is also directed to an image forming method, comprising: a first liquid deposition step of depositing a first liquid onto a recording medium; and a second liquid ejection step of ejecting a second liquid according to image data for printing, from an ejection head onto the first liquid deposited on the recording medium in the first liquid depositing step, wherein a contact angle of the first liquid with respect to the recording medium is not less than 60°, and a contact angle of a mixed liquid of the first liquid and the second liquid with respect to the recording medium is not less than 60°.

According to the present invention, by setting the contact angle of the first liquid with respect to the recording medium to be not less than 60° and the contact angle of the mixed liquid of the first liquid and the second liquid with respect to the recording medium to be not less than 60°, as the conditions of the characteristics of the first liquid and the second liquid used when forming images by depositing the first liquid onto the recording medium and then ejecting the second liquid onto the first liquid, and by using the two liquids having these properties, it is possible to cause the first liquid and the second liquid to react together reliably on the recording medium, and hence permeation of the first liquid and the mixed liquid of the first liquid and the second liquid is suppressed, and it becomes possible to form an image of high quality on the recording medium.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of an inkjet recording apparatus according to an embodiment of the present invention;

FIG. 2 is a principal plan diagram of the peripheral area of a print unit in the inkjet recording apparatus shown in FIG. 1;

FIG. 3A is a plan view perspective diagram showing an embodiment of the composition of a print head, FIG. 3B is a principal enlarged view of FIG. 3A, and FIG. 3C is a plan view perspective diagram showing a further embodiment of the composition of a full line head;

FIG. 4 is a cross-sectional view along line 4-4 n FIGS. 3A and 3B;

FIG. 5 is an enlarged view showing a nozzle arrangement in the print head shown in FIG. 3A;

FIG. 6 is a schematic drawing showing the composition of an ink supply system in the inkjet recording apparatus;

FIG. 7 is a principal block diagram showing the system composition of the inkjet recording apparatus;

FIG. 8 is a table showing the relationship between the contact angle of the treatment liquid and the contact angle of the ink;

FIGS. 9A to 9D are schematic drawings showing a situation where a droplet of ink is deposited onto treatment liquid which has been deposited on the recording medium;

FIGS. 10A to 10D are schematic drawings showing a case where the contact angle of the treatment liquid is less than 60°;

FIGS. 11A to 11D are schematic drawings showing a case where the contact angle of the ink is less than 60°;

FIG. 12 is a table showing the relationship between the surface tension of a treatment liquid containing a cationic surface-active agent and the surface tension of the ink;

FIG. 13 is a table showing the relationship between the surface tension of a treatment liquid containing a nonionic surface-active agent and the surface tension of the ink; and

FIGS. 14A to 14C are structural formulas of examples of anionic dye compounds which the ink can include.

### DETAILED DESCRIPTION OF THE PREFERRED EMBODIMENTS

General Composition Of Inkjet Recording Apparatus

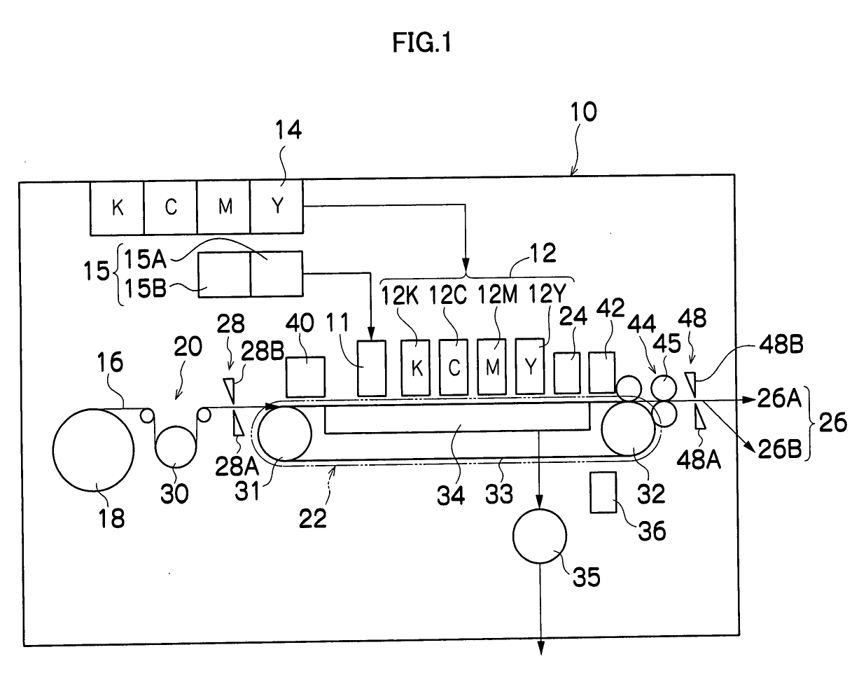

FIG. 1 is a diagram of the general composition of an inkjet recording apparatus according to an embodiment of the present invention. As shown in FIG. 1, the inkjet recording apparatus 10 comprises: a treatment liquid ejection head 11 (corresponding to a first treatment liquid application device); a printing unit 12, which has a plurality of inkjet heads (hereafter, called “heads”) 12K, 12C, 12M, and 12Y provided for colors of ink (corresponding to a second liquid) of black (K), cyan (C), magenta (M), and yellow (Y), respectively; an ink storing and loading unit 14, which stores inks of K, C, M and Y to be supplied to the print heads 12K, 12C, 12M, and 12Y; a treatment liquid storing and loading unit 15, which stores treatment liquid to be supplied to the treatment liquid ejection 11; a media supply unit 18, which supplies a recording medium 16; a decurling unit 20, which removes curl in the recording medium 16; a suction belt conveyance unit 22, which is disposed facing the nozzle face (ink-droplet ejection face) of the print unit 12, and conveys the recording medium 16 while keeping the recording medium 16 flat; a print determination unit 24, which reads the printed result produced by the printing unit 12; and an output unit 26, which outputs the recorded recording medium 16 (printed matter) to the exterior.

The ink storing and loading unit 14 has ink tanks for storing the inks of K, C, M and Y to be supplied to the heads 12K, 12C, 12M, and 12Y, and the tanks are connected to the heads 12K, 12C, 12M, and 12Y by means of prescribed channels. The ink storing and loading unit 14 has a warning device (for example, a display device or an alarm sound generator) for warning when the remaining amount of any ink is low, and has a mechanism for preventing loading errors among the colors.

The treatment liquid storing and loading unit 15 has treatment liquid tanks 15A and 15B, which store a plurality of types of treatment liquids and are connected to the treatment liquid ejection head 11 by means of a prescribed channel. For the sake of convenience, hereinafter, the treatment liquid supplied from treatment liquid tank 15A is referred to as “treatment liquid A”, and the treatment liquid supplied from treatment liquid tank 15B is referred to as “treatment liquid B”.

In FIG. 1, the two treatment liquid tanks 15A and 15B are depicted, and a composition is shown in which the two types of treatment liquids A and B are supplied to the common treatment liquid ejection head 11, and the treatment liquid A or the treatment liquid B is ejected from the treatment liquid ejection head 11 by selectively switching the liquid types, but the number of types of treatment liquid is not limited in particular, and any number of types (at least one type) of treatment liquid may be used. Furthermore, it is also possible to adopt a composition in which a plurality of independent treatment liquid ejection heads are provided correspondingly to the liquid types, in accordance with the number of types of treatment liquid.

Similarly to the ink storing and loading unit 14, the treatment liquid storing and loading unit 15, also comprises a warning device (for example, a display device or an alarm sound generator) for warning when the remaining amount of any treatment liquid is low, and has a mechanism for preventing loading errors among the treatment liquids.

The ink used in the present embodiment is, for instance, colored ink including anionic polymer, namely, a polymer containing negatively charged surface-active ions. Furthermore, the treatment liquid used in the present embodiment is, for instance, a transparent reaction promotion agent including cationic polymer, namely, a polymer containing positively charged surface-active ions.

When the ink and the treatment liquid are mixed, an insolubilization and/or fixing reaction of the coloring material in the ink proceeds due to a chemical reaction. Here, the term “insolubilization” includes a phenomenon whereby the coloring material separates or precipitates from the solvent, a phenomenon whereby the liquid in which the coloring material is dissolved changes (coagulates) to a solid phase, or a phenomenon whereby the liquid increases in viscosity and hardens. Furthermore, the term “fixing” may indicate a mode where the coloring material is held on the surface of the recording medium 16, a mode where the coloring material permeates into the recording medium 16 and is held therein, or a mode combining these states.

The reaction speed and the characteristics (contact angle, surface tension, or the like) of the ink and the treatment liquids can be adjusted by regulating the respective compositions, the concentration of the materials contributing to the reaction, or the like of the ink and the treatment liquids, and desired ink insolubility and/or ink permeation speed can be achieved. The properties of the treatment liquids and the ink used in the present embodiment are described later.

With respect to the supply system of the recording medium 16, a magazine for rolled paper (continuous paper) is shown as an embodiment of the media supply unit 18 in FIG. 1; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which a plurality of types of recording medium can be used, it is preferable that an information recording medium such as a bar code and a wireless tag containing information about the type of recording medium is attached to the magazine, and by reading the information contained in the information recording medium with a predetermined reading device, the type of recording medium to be used (type of medium) is automatically determined, and ejection is controlled so that the treatment liquid and the ink are ejected in an appropriate manner in accordance with the type of medium.

The recording medium 16 delivered from the media supply unit 18 retains curl due to having been loaded in the magazine. In order to remove the curl, heat is applied to the recording medium 16 in the decurling unit 20 by a heating drum 30 in the direction opposite from the curl direction in the magazine. The heating temperature at this time is preferably controlled so that the recording medium 16 has a curl in which the surface on which the print is to be made is slightly round outward.

In the case of the configuration in which roll paper is used, a cutter (first cutter) 28 is provided as shown in FIG. 1, and the continuous paper is cut into a desired size by the cutter 28. The cutter 28 has a stationary blade 28A, whose length is not less than the width of the conveyor pathway of the recording medium 16, and a round blade 28B, which moves along the stationary blade 28A. The stationary blade 28A is disposed on the reverse side of the printed surface of the recording medium 16, and the round blade 28B is disposed on the printed surface side across the conveyor pathway. When cut papers are used, the cutter 28 is not required.

The decurled and cut recording medium 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the printing unit 12 and the sensor face of the print determination unit 24 forms a horizontal plane (flat plane).

The belt 33 has a width that is greater than the width of the recording medium 16, and a plurality of suction apertures (not shown) are formed on the belt surface. A suction chamber 34 is disposed in a position facing the sensor surface of the print determination unit 24 and the nozzle surface of the printing unit 12 on the interior side of the belt 33, which is set around the rollers 31 and 32, as shown in FIG. 1. The suction chamber 34 provides suction with a fan 35 to generate a negative pressure, and the recording medium 16 is held on the belt 33 by suction.

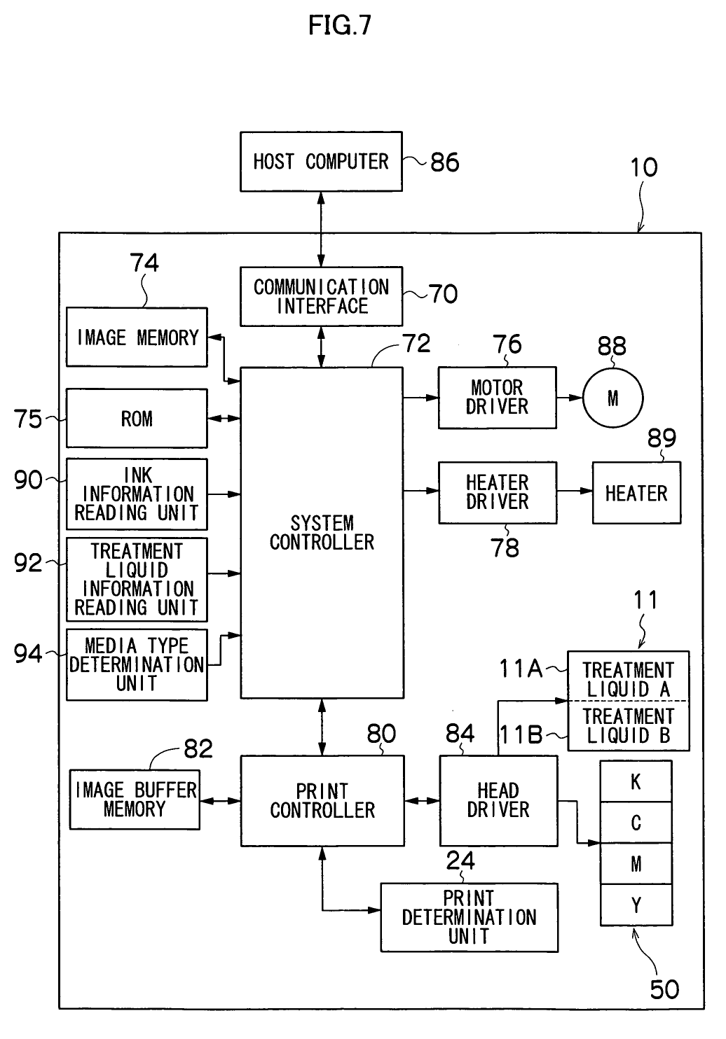

The belt 33 is driven in the clockwise direction in FIG. 1 by the motive force of a motor 88 (shown in FIG. 7) being transmitted to at least one of the rollers 31 and 32, which the belt 33 is set around, and the recording medium 16 held on the belt 33 is conveyed from left to right in FIG. 1. More specifically, the suction belt conveyance unit 22 functions as a relative movement device which causes the recording medium 16, and the treatment liquid ejection 11 which deposits treatment liquid onto the recording medium 16 (first liquid deposition device) and the heads 12K, 12C, 12M and 12Y (ejection devices) which eject ink, to move relatively with respect to each other.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, embodiments thereof include a configuration in which the belt 33 is nipped with cleaning rollers such as a brush roller and a water absorbent roller, an air blow configuration in which clean air is blown onto the belt 33, or a combination of these. In the case of the configuration in which the belt 33 is nipped with the cleaning rollers, it is preferable to make the line velocity of the cleaning rollers different than that of the belt 33 to improve the cleaning effect.

The inkjet recording apparatus 10 can comprise a roller nip conveyance mechanism, in which the recording medium 16 is pinched and conveyed with nip rollers, instead of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the printing unit 12 in the media conveyance pathway formed by the suction belt conveyance unit 22. The heating fan 40 blows heated air onto the recording medium 16 to heat the recording medium 16 immediately before printing so that the ink deposited on the recording medium 16 dries more easily.

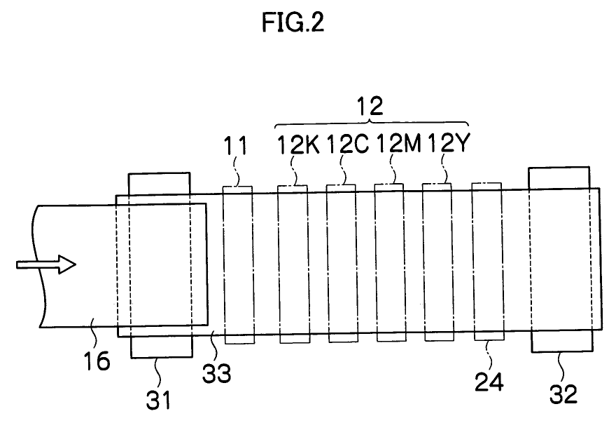

The treatment liquid ejection head 11 and the print heads 12K, 12M, 12C and 12Y of the print unit 12 are full line heads having a length corresponding to the maximum width of the recording medium 16 used with the inkjet recording apparatus 10 (see FIG. 2), and comprising nozzles for ejecting ink or nozzles for ejecting treatment liquid arranged on a nozzle face through a length exceeding at least one edge of the maximum-size recording paper (namely, the full width of the printable range).

The heads 12K, 12C, 12M and 12Y of the print unit 12 are arranged in the sequence of the colors, black (K), cyan (C), magenta (M) and yellow (Y), from the upstream side, in the direction of conveyance of the recording medium 16, and the treatment liquid ejection head 11 is disposed further to the upstream side of the print unit 12. The heads 11, 12K, 12C, 12M and 12Y are disposed in fixed positions in such a manner that they extend in a direction substantially perpendicular to the conveyance direction of the recording medium 16. By means of this head arrangement, it is possible to cause the treatment liquid to adhere to the print surface (recording surface) of the recording medium 16 by means of the treatment liquid ejection head 11, before ejecting colored inks from the print unit 12.

A color image can be formed on the recording medium 16 by ejecting inks of different colors from the heads 12K, 12C, 12M and 12Y, respectively, onto the recording medium 16 while the recording medium 16 is conveyed by the suction belt conveyance unit 22.

By adopting a configuration in which the full line heads 12K, 12C, 12M and 12Y having nozzle rows covering the full paper width are provided for the respective colors in this way, it is possible to record an image on the full surface of the recording medium 16 by performing just one operation of relatively moving the recording medium 16 and the printing unit 12 in the paper conveyance direction (the sub-scanning direction), in other words, by means of a single sub-scanning action. Higher-speed printing is thereby made possible and productivity can be improved in comparison with a shuttle type head configuration in which a recording head reciprocates in the main scanning direction.

Although the configuration with the KCMY four standard colors is described in the present embodiment, combinations of the ink colors and the number of colors are not limited to those. Light inks, dark inks or special color inks can be added as required. For example, a configuration is possible in which inkjet heads for ejecting light-colored inks such as light cyan and light magenta are added. Furthermore, there are no particular restrictions of the sequence in which the heads of respective colors are arranged.

The print determination unit 24 shown in FIG. 1 has an image sensor for capturing an image of the ink-droplet deposition result of the printing unit 12, and functions as a device to check for ejection defects such as clogs of the nozzles in the printing unit 12 from the ink-droplet deposition results evaluated by the image sensor.

The print determination unit 24 of the present embodiment is configured with at least a line sensor having rows of photoelectric transducing elements with a width that is greater than the ink-droplet ejection width (image recording width) of the heads 12K, 12C, 12M, and 12Y. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

A test pattern or the target image printed by the print heads 12K, 12C, 12M, and 12Y of the respective colors is read in by the print determination unit 24, and the ejection performed by each head is determined. The ejection determination includes detection of the ejection, measurement of the dot size, and measurement of the dot formation position.

A post-drying unit 42 is disposed following the print determination unit 24. The post-drying unit 42 is a device to dry the printed image surface, and includes a heating fan, for example. It is also possible to provide a solvent removal unit which removes the solvents (treatment liquid solvent and ink solvent) that remain on the recording medium 16, either instead of or in conjunction with the post-drying unit 42. There is also a mode of the solvent removal unit in which the solvents on the recording medium 16 are removed by absorption, by placing an absorbing member, such as a nonwoven cloth or a porous member, in contact with the recording medium 16. It is sufficient that the absorbing member makes contact with the solvents on the surface of the recording medium 16. Furthermore, by changing the contact pressure of the absorbing member against the recording medium 16, it is possible to control the time required in order to remove the solvents. By removing the residual solvents on the recording medium 16 rapidly in this fashion, it is possible to prevent the occurrence of cockling which may degrade the image quality on the recording medium 16, and hence a desirable image is formed on the recording medium 16.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

In cases in which printing is performed using dye-based ink on a porous paper, blocking the pores of the paper by the application of pressure prevents the ink from coming into contact with ozone and other substances that cause dye molecules to break down, and therefore has the effect of increasing the durability of the image.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively.

When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not shown in FIG. 1, the paper output unit 26A for the target prints is provided with a sorter for collecting prints according to print orders.

Structure of Head

Next, the structure of the heads is described. The heads 12K, 12C, 12M and 12Y of the respective ink colors have the same structure, and a reference numeral 50 is hereinafter designated to any of the heads.

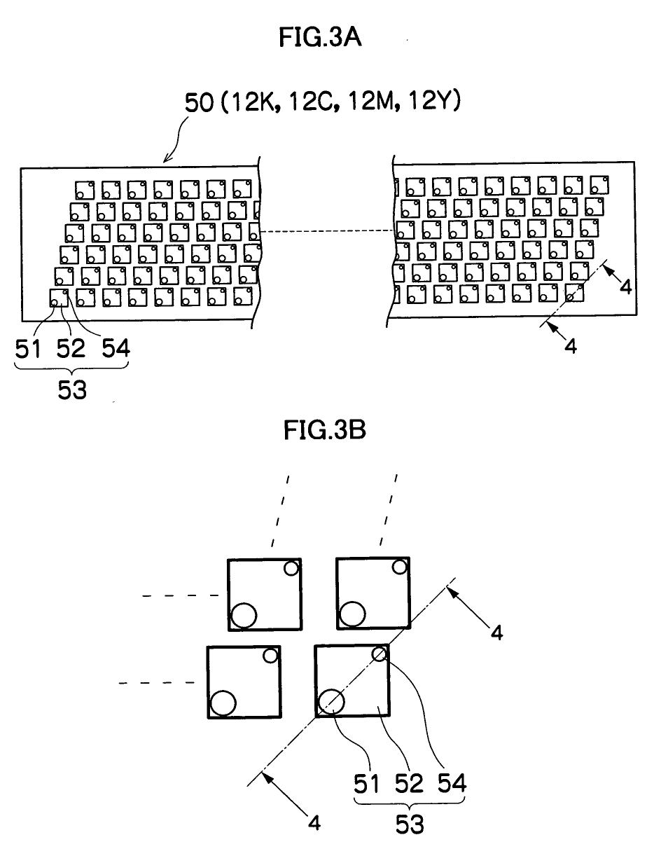

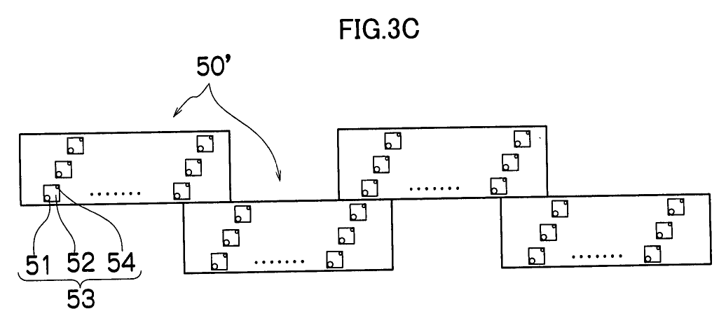

FIG. 3A is a perspective plan view showing an embodiment of the configuration of the head 50, FIG. 3B is an enlarged view of a portion thereof, FIG. 3C is a perspective plan view showing another embodiment of the configuration of the head 50, and FIG. 4 is a cross-sectional view taken along the line 4-4 in FIGS. 3A and 3B, showing the inner structure of a droplet ejection element (an ink chamber unit for one nozzle 51).

The nozzle pitch in the head 50 should be minimized in order to maximize the resolution of the dots printed on the surface-of the recording medium 16. As shown in FIGS. 3A and 3B, the head 50 according to the present embodiment has a structure in which an ink chamber unit 53, each comprising a nozzle 51 forming an ink droplet ejection port, a pressure chamber 52 corresponding to the nozzle 51, and the like, are disposed two-dimensionally in the form of a staggered matrix, and hence the effective nozzle interval (the projected nozzle pitch) as projected in the lengthwise direction of the head (the direction perpendicular to the paper conveyance direction) is reduced and high nozzle density is achieved.

The mode of forming nozzle rows of a length corresponding to the entire width of the recording medium 16 or greater in a direction substantially perpendicular to the conveyance direction of the recording medium 16 is not limited to the embodiment described above. For example, instead of the configuration in FIG. 3A, as shown in FIG. 3C, a line head having nozzle rows of a length corresponding to the entire width of the recording medium 16 can be formed by arranging and combining, in a staggered matrix, short head units 50′ having a plurality of nozzles 51 arrayed in a two-dimensional fashion.

As shown in FIGS. 3A and 3B, the planar shape of the pressure chamber 52 provided for each nozzle 51 of the head 50 is substantially a square, and an outlet to the nozzle 51 and an inlet of supplied ink (supply port) 54 are disposed in both corners on a diagonal line of the square.

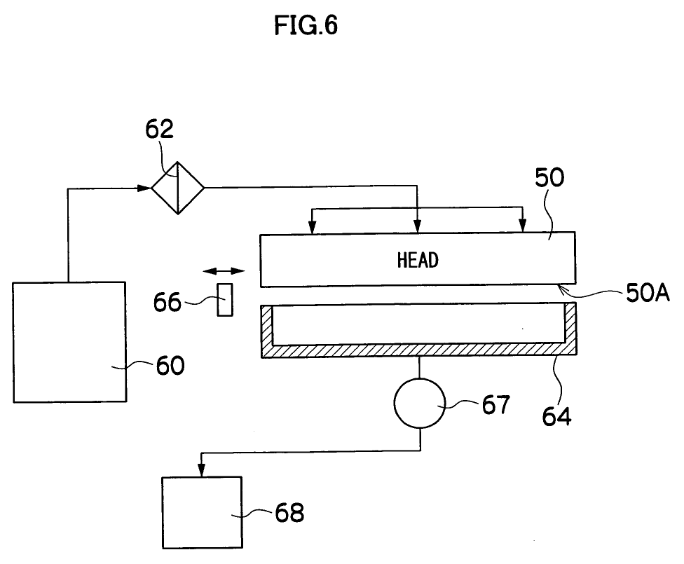

As shown in FIG. 4, each pressure chamber 52 is connected to a common channel 55 through the supply port 54. The common channel 55 is connected to an ink tank 60 (not shown in FIG. 4, but shown in FIG. 6), which is a base tank that supplies ink, and the ink supplied from the ink tank 60 is delivered through the common flow channel 55 in FIG. 4 to the pressure chambers 52.

An actuator 58 provided with an individual electrode 57 is bonded to a pressure plate 56 (a diaphragm that also serves as a common electrode) which forms the ceiling of the pressure chamber 52. When a drive voltage is applied to the individual electrode 57, the actuator 58 is deformed, the volume of the pressure chamber 52 is thereby changed, and the pressure in the pressure chamber 52 is thereby changed, so that the ink inside the pressure chamber 52 is thus ejected through the nozzle 51. When ink is ejected, new ink is supplied to the pressure chamber 52 from the common flow channel 55 through the supply port 54. The actuator 58 is preferably a piezoelectric element.

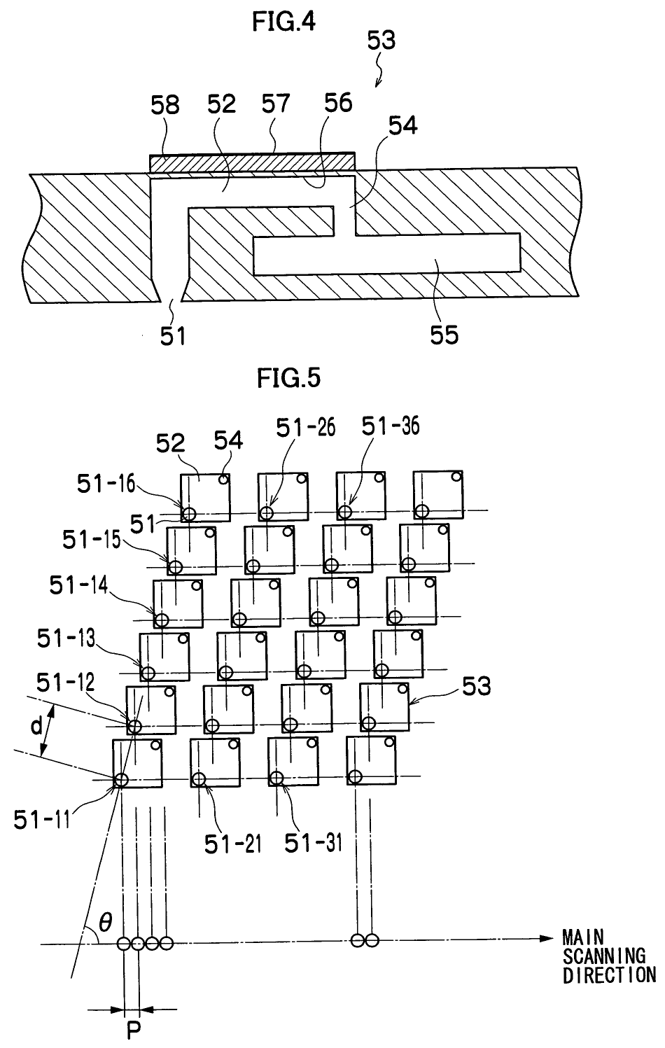

As shown in FIG. 5, the high-density nozzle head according to the present embodiment is achieved by arranging the plurality of ink chamber units 53 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which the plurality of ink chamber units 53 are arranged at a uniform pitch d in line with a direction forming an angle of θ with respect to the main scanning direction, the pitch P of the nozzles projected so as to align in the main scanning direction is d×cos θ, and hence the nozzles 51 can be regarded to be equivalent to those arranged linearly at a fixed pitch P along the main scanning direction. Such configuration makes it possible to achieve a high-density nozzle row.

In a full-line head comprising rows of nozzles that have a length corresponding to the entire width of the image recordable width, the “main scanning” is defined as printing one line (a line formed of a row of dots, or a line formed of a plurality of rows of dots) in the width direction of the recording medium (the direction perpendicular to the conveyance direction of the recording medium) by driving the nozzles in one of the following ways: (1) simultaneously driving all the nozzles; (2) sequentially driving the nozzles from one side toward the other; and (3) dividing the nozzles into blocks and sequentially driving the nozzles from one side toward the other in each of the blocks.

In particular, when the nozzles 51 arranged in a matrix such as that shown in FIG. 5 are driven, the main scanning according to the above-described (3) is preferred. More specifically, the nozzles 51-11, 51-12, 51-13, 51-14, 51-15 and 51-16 are treated as a block (additionally; the nozzles 51-21, . . . , 51-26 are treated as another block; the nozzles 513-31, . . . 51-36 are treated as another block; . . . ); and one line is printed in the width direction of the recording medium 16 by sequentially driving the nozzles 51-11, 51-12, . . . , 51-16 in accordance with the conveyance velocity of the recording medium 16.

On the other hand, “sub-scanning” is defined as to repeatedly perform printing of one line (a line formed of a row of dots, or a line formed of a plurality of rows of dots) formed by the main scanning, while moving the full-line head and the recording medium 16 relatively to each other.

In implementing the present invention, the arrangement of the nozzles is not limited to that of the embodiment illustrated. Moreover, a method is employed in the present embodiment where an ink droplet is ejected by means of the deformation of the actuator 58, which is typically a piezoelectric element; however, in implementing the present invention, the method used for discharging ink is not limited in particular, and instead of the piezo jet method, it is also possible to apply various types of methods, such as a thermal jet method where the ink is heated and bubbles are caused to form therein by means of a heat generating body such as a heater, ink droplets being ejected by means of the pressure applied by these bubbles.

Although not illustrated here, the structure of the treatment liquid ejection head 11 is approximately the same as the head 50 of the print unit 12 described above. The treatment liquid ejection head 11 according to the present embodiment is a head capable of selectively ejecting two types of treatment liquids, and it has a plurality of nozzle rows corresponding to types of treatment liquids (here, taken to be a nozzle row for ejecting treatment liquid A and a nozzle row for ejecting treatment liquid B2). Naturally, a flow channel for treatment liquid A and a flow channel for treatment liquid B are formed separately inside the treatment liquid ejection head 11 (separate flow channel structures being adopted in such a manner that the different types of treatment liquids do not mix together).

Since the treatment liquid is applied to the recording medium 16 in a substantially uniform (even) fashion in the region where ink droplets are to be ejected, it is not necessary to form dots to a high resolution, in comparison with the ink. Consequently, the treatment liquid ejection head 11 may be composed with a reduced number of nozzles (a reduced nozzle density) in comparison with the print head 50 for ejecting ink. Furthermore, a composition may also be adopted in which the nozzle diameter of the treatment liquid ejection head 11 is greater than the nozzle diameter of the print head 50 for ejecting ink.

Configuration of Ink Supply System

FIG. 6 is a schematic drawing showing the configuration of the ink supply system in the inkjet recording apparatus 10. The ink tank 60 is a base tank that supplies ink to the head 50 and is set in the ink storing and loading unit 14 described with reference to FIG. 1. More specifically, the ink tank 60 in FIG. 6 is equivalent to the ink storing and loading unit 14 in FIG. 1 described above. The aspects of the ink tank 60 include a refillable type and a cartridge type: when the remaining amount of ink is low, the ink tank 60 of the refillable type is filled with ink through a filling port (not shown) and the ink tank 60 of the cartridge type is replaced with a new one. In order to change the ink type in accordance with the intended application, the cartridge type is suitable, and it is preferable to represent the ink type information with a bar code or the like on the cartridge, and to perform ejection control in accordance with the ink type.

A filter 62 for removing foreign matters and bubbles is disposed between the ink tank 60 and the head 50 as shown in FIG. 6. The filter mesh size in the filter 62 is preferably equivalent to or less than the diameter of the nozzle. Although not shown in FIG. 6, it is preferable to provide a sub-tank integrally to the print head 50 or nearby the head 50. The sub-tank has a damper function for preventing variation in the internal pressure of the head and a function for improving refilling of the print head.

The inkjet recording apparatus 10 is also provided with a cap 64 as a device to prevent the nozzles 51 from drying out or to prevent an increase in the ink viscosity in the vicinity of the nozzles 51, and a cleaning blade 66 as a device to clean the nozzle face 50A. A maintenance unit including the cap 64 and the cleaning blade 66 can be relatively moved with respect to the head 50 by a movement mechanism (not shown), and is moved from a predetermined holding position to a maintenance position below the head 50 as required.

The cap 64 is displaced up and down relatively with respect to the head 50 by an elevator mechanism (not shown). When the power of the inkjet recording apparatus 10 is turned OFF or when in a print standby state, the cap 64 is raised to a predetermined elevated position so as to come into close contact with the head 50, and the nozzle face 50A is thereby covered with the cap 64.

The cleaning blade 66 is composed of rubber or another elastic member, and can slide on the nozzle surface 50A (surface of the nozzle plate) of the head 50 by means of a blade movement mechanism (not shown). When ink droplets or foreign matter has adhered to the surface of nozzle plate, the surface of the nozzle plate is wiped by sliding the cleaning blade 66 on the nozzle plate.

During printing or standby, when the frequency of use of specific nozzles is reduced and ink viscosity increases in the vicinity of the nozzles, a preliminary discharge is made to eject the degraded ink toward the cap 64 (also used as an ink receptor).

When a state in which ink is not ejected from the head 50 continues for a certain amount of time or longer, the ink solvent in the vicinity of the nozzles 51 evaporates and ink viscosity increases. In such a state, ink can no longer be ejected from the nozzle 51 even if the actuator 58 for the ejection driving is operated. Before reaching such a state (in a viscosity range that allows ejection by the operation of the actuator 58) the actuator 58 is operated to perform the preliminary discharge to eject the ink whose viscosity has increased in the vicinity of the nozzle toward the ink receptor. After the nozzle surface is cleaned by a wiper such as the cleaning blade 66 provided as the cleaning device for the nozzle face 50A, a preliminary discharge is also carried out in order to prevent the foreign matter from becoming mixed inside the nozzles 51 by the wiper sliding operation. The preliminary discharge is also referred to as “dummy discharge”, “purge”, “liquid discharge”, and so on.

On the other hand, if air bubbles become intermixed into the nozzle 51 or pressure chamber 52, or if the rise in the viscosity of the ink inside the nozzle 51 exceeds a certain level, then it may not be possible to eject ink in the preliminary ejection operation described above. In cases of this kind, a cap 64 forming a suction device is pressed against the nozzle surface 50A of the print head 50, and the ink inside the pressure chambers 52 (namely, the ink containing air bubbles of the ink of increased viscosity) is suctioned by a suction pump 67. The ink suctioned and removed by means of this suction operation is sent to a collection tank 68. The ink collected in the collection tank 68 may be reused, or if reuse is not possible, it may be discarded.

Since the suctioning operation is performed with respect to all of the ink in the pressure chambers 52, it consumes a large amount of ink, and therefore, desirably, preliminary ejection is carried out while the increase in the viscosity of the ink is still minor. The suction operation is also carried out when ink is loaded into the print head 50 for the first time, and when the head starts to be used after being idle for a long period of time.

The supply system for the treatment liquid is not shown, but it is substantially the same as the composition of the ink supply system shown in FIG. 6. In the present embodiment, as described in FIG. 1, two types of treatment liquids A and B are supplied respectively from the treatment liquid tanks 15A and 15B to the treatment liquid ejection head 11.

Description of Control System

FIG. 7 is a principal block diagram showing the system configuration of the inkjet recording apparatus 10. The inkjet recording apparatus 10 comprises a communication interface 70, a system controller 72, an image memory 74, a ROM 75, a motor driver 76, a heater driver 78, a print controller 80, an image buffer memory 82, a head driver 84, and the like.

The communication interface 70 is an interface unit for receiving image data sent from a host computer 86. A serial interface such as USB, IEEE1394, Ethernet, wireless network, or a parallel interface such as a Centronics interface may be used as the communication interface 70. A buffer memory (not shown) may be mounted in this portion in order to increase the communication speed.

The image data sent from the host computer 86 is received by the inkjet recording apparatus 10 through the communication interface 70, and is temporarily stored in the image memory 74. The image memory 74 is a storage device for temporarily storing images inputted through the communication interface 70, and data is written and read to and from the image memory 74 through the system controller 72. The image memory 74 is not limited to a memory composed of semiconductor elements, and a hard disk drive or another magnetic medium may be used.

The system controller 72 is constituted by a central processing unit (CPU) and peripheral circuits thereof, and the like, and it functions as a control device for controlling the whole of the inkj et recording apparatus 10 in accordance with a prescribed program, as well as a calculation device for performing various calculations. More specifically, the system controller 72 controls the various sections, such as the communication interface 70, image memory 74, motor driver 76, heater driver 78, and the like, as well as controlling communications with the host computer 86 and writing and reading to and from the image memory 74, and it also generates control signals for controlling the motor 88 and heater 89 of the conveyance system.

The program executed by the CPU of the system controller 72 and the various types of data which are required for control procedures are stored in the ROM 75. The ROM 75 may be a non-writeable storage device, or it may be a rewriteable storage device, such as an EEPROM. The image memory 74 is used as a temporary storage region for the image data, and it is also used as a program development region and a calculation work region for the CPU.

The motor driver (drive circuit) 76 drives the motor 88 in accordance with commands from the system controller 72. The heater driver (drive circuit) 78 drives the heater 89 of the post-drying unit 42 or the like in accordance with commands from the system controller 72.

The print controller 80 has a signal processing function for performing various tasks, compensations, and other types of processing for generating print control signals from the image data stored in the image memory 74 in accordance with commands from the system controller 72 so as to supply the generated print data (dot data) to the head driver 84. Prescribed signal processing is carried out in the print controller 80, and the droplet ejection range of the treatment liquid, the ejection amount and the ejection timing of the ink are controlled via the head driver 84, on the basis of the print data. By this means, prescribed dot size and dot positions can be achieved.

The print controller 80 is provided with the image buffer memory 82; and image data, parameters, and other data are temporarily stored in the image buffer memory 82 when image data is processed in the print controller 80. The aspect shown in FIG. 7 is one in which the image buffer memory 82 accompanies the print controller 80; however, the image memory 74 may also serve as the image buffer memory 82. Also possible is an aspect in which the print controller 80 and the system controller 72 are integrated to form a single processor.

The head driver 84 drives the actuators 58 in the respective color heads 50, on the basis of the print data supplied from the print controller 80, and it also drives the actuators of the treatment liquid ejection head 11. A feedback control system for maintaining constant drive conditions in the head may be included in the head driver 84.

The image data to be printed is externally inputted through the communication interface 70, and is stored in the image memory 74. In this stage, the RGB image data is stored in the image memory 74.

The image data stored in the image memory 74 is sent to the print controller 80 through the system controller 72, and is converted to the dot data for each ink color by a half-toning technique, such as dithering or error diffusion, in the print controller 80. In this inkjet recording apparatus 10, an image which appears to have a continuous tonal graduation to the human eye is formed by changing the droplet ejection density and the dot size of fine dots created by ink (coloring material), and therefore, it is necessary to convert the input digital image into a dot pattern which reproduces the tonal graduations of the image (namely, the light and shade toning of the image) as faithfully as possible.

In other words, the print controller 80 performs processing for converting the input RGB image data into dot data for the four colors of K, C, M and Y Furthermore, the print controller 80 judges the droplet ejection region of the treatment liquid (the region of the recording surface where ejection of treatment liquid is required) on the basis of the dot data of the respective colors, and thus generates dot data for the ejection of treatment liquid droplets. The dot data (for the treatment liquid and the respective colors) generated by the print controller 80 is stored in the image buffer memory 82.

The head driver 84 generates drive control signals for the treatment liquid ejection head 11 and the print heads 50 of the respective ink colors, on the basis of the dot data stored in the image buffer memory 82. By supplying the drive control signals generated by the head driver 84 to the treatment liquid ejection head 11 and the print heads 50 of respective ink colors, treatment liquid is ejected from the treatment liquid ejection head 11 and inks are ejected from the print heads 50. By controlling the ejection of treatment liquid from the treatment liquid ejection head 11 and the ejection of ink from the print head 50 in synchronism with the conveyance speed of the recording medium 16, an image is formed on the recording medium 16.

In other words, the print controller 80 functions as an ejection control device for controlling the ejection operation of the head 50 which functions as an ejection device that ejects ink including coloring material (second liquid) onto the recording medium 16, in such a manner that the treatment liquid deposited on the recording medium 16 and the ink ejected from the head 50 mix together.

As shown in FIG. 1, the print determination unit 24 is a block including a line sensor, which reads in the image printed on the recording medium 16, performs various signal processing operations, and the like, and determines the print situation (presence/absence of ejection, variation in droplet ejection, optical density, and the like), these determination results being supplied to the print controller 80.

According to requirements, the print controller 80 makes various corrections with respect to the head 50 on the basis of information obtained from the print determination unit 24. Furthermore, the system controller 72 implements control for carrying out preliminary ejection, suctioning, and other prescribed restoring processes on the head 50, on the basis of the information obtained from the print determination unit 24.

The inkjet recording apparatus 10 according to this embodiment also has an ink information reading unit 90, a treatment liquid information reading unit 92 and a media type determination unit 94. The ink information reading unit 90 is a device for reading in information relating to the ink type. More specifically, it is possible to use, for example, a device which reads in ink identification information or ink properties information from the shape of the cartridge in the ink tank 60 (see FIG. 6) (a specific shape which allows the ink type to be identified), or from a bar code or IC chip incorporated into the cartridge. Besides this, it is also possible for an operator to input the required information by means of a user interface.

Similarly, the treatment liquid information reading unit 92 is a device for acquiring information relating to the type of treatment liquid. More specifically, it is possible to use, for example, a device which reads in treatment liquid identification information or properties information from the shape of the cartridge (a specific shape which allows the liquid type to be identified) in the treatment liquid tanks 15A and 15B (see FIG. 1), or from a bar code or IC chip incorporated into the cartridge. Besides this, it is also possible for an operator to input the required information by means of a user interface.

The media type determination unit 94 is a device for determining the type and size of the recording medium. This section uses, for example, a device for reading in information (identification information or media type information) from a bar code attached to the magazine in the media supply unit 18, or sensors disposed at a suitable position in the paper conveyance path (a media width determination sensor, a sensor for determining the thickness of the media, a sensor for determining the reflectivity of the media, and so on). A suitable combination of these elements may also be used. Furthermore, it is also possible to adopt a composition in which information relating to the paper type, size, or the like, is specified by means of inputs made via a prescribed user interface, instead of or in conjunction with such automatic determination devices.

The information acquired from the various devices, namely, the ink information reading unit 90, the treatment liquid information reading unit 92 and the media type determination unit 94 is sent to the system controller 72, where it is used to select the treatment liquid and to control ejection of the ink (namely, the ejection volume and ejection timing), in such a manner that suitable droplet ejection is performed in accordance with the conditions. More specifically, the system controller 72 judges the type of the recording medium 16 on the basis of the information obtained from the respective devices of the ink information reading unit 90, the treatment liquid reading unit 92 and the media type determination unit 94, and it decides whether or not to use a treatment liquid and, if a treatment liquid is to be used, it selects the type of liquid and controls the volume to be ejected.

As described in FIG. 1, in the inkjet recording apparatus 10 according to the present embodiment, a composition is adopted in which the treatment liquid ejection head 11 is disposed in the most upstream position of the print unit 12, and before ejecting droplets of ink from the print unit 12, the treatment liquid is previously applied to the print surface of the recording medium 16 by means of a single operation by the upstream treatment liquid ejection head 11. In the case of this composition, the amount of treatment liquid on the recording medium 16 gradually declines as the volume of the ink droplets ejected by the print unit 12 increases, and therefore, the further the position toward the downstream side of the print unit 12, the smaller the amount of treatment liquid on the recording medium 16. Since it is necessary for some treatment liquid to be remaining in the vicinity of the surface of the recording medium 16 until droplet ejection by the head in the final stage (furthest downstream position) of the print unit 12 (in FIG. 1, the yellow head 12Y) has been completed, then the amount of treatment liquid ejected by the treatment liquid ejection head 11 is determined on the basis of the type of recording medium 16, the properties of the treatment liquid and the ink (for example, the contact angle with respect to the recording medium, the surface tension, and the like), the ejected ink volume, the conveyance speed of the recording medium 16, and the like, in such a manner that presence of the required amount of treatment liquid can be ensured.

Description of Contact Anile

In the present inkjet recording apparatus 10, the treatment liquid, the ink, and the mixed liquid of the treatment liquid and the ink used have contact angles α1, α2 and α3, respectively, of 60° or greater within one second on the recording medium 16 (one second after landing on the medium). The contact angles of the treatment liquid, the ink, and the mixed liquid of the treatment liquid and the ink are adjusted by altering the type of (nonionic, cationic, anionic, or the like) surface-active agent and the volume of surface-active agent contained in the liquids, and a detailed description is described later,. In the inkjet recording apparatus 10 in the present embodiment, the two types of treatment liquid having different properties are provided, in such a manner that these treatment liquids are used selectively in accordance with the type of recording medium 16.

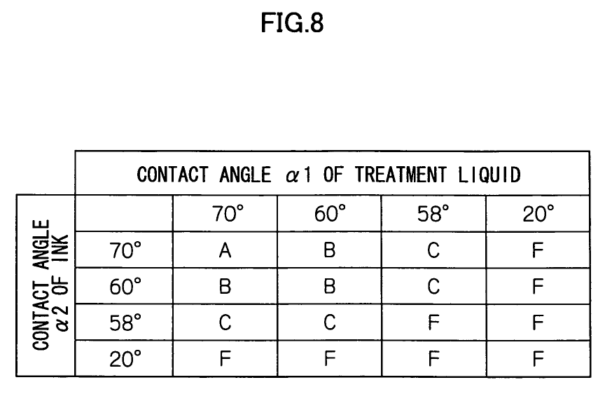

FIG. 8 is a table showing the visibility of bleeding of dots formed on the recording medium 16 in a case where the contact angle α1 of the treatment liquid and the contact angle α2 of the ink are changed. FIG. 8 shows the results of visual observation of dots, wherein “A” indicates a state where bleeding is not visible in the dots, “B” indicates a state where bleeding occurs in the dots but the bleeding is hardly visible (a state where tolerable bleeding occurs), “C” indicates a state where visible bleeding occurs, and “F” indicates a state where bleeding which degrades the image quality occurs in the dots.

In the dot bleeding observation experiments for which the results are shown in FIG. 8, normal paper (recycled paper) is used as the recording medium, and ink droplets are ejected in a state where treatment liquid has been deposited on the recording medium by means of droplet ejection or application, and the state of the dots one second after landing of the ink is observed visually.

According to FIG. 8, provided that the contact angle α1 of the treatment liquid and the contact angle α2 of the ink are not less than 60°, then the bleeding which occurs in the dots formed on the recording medium will be of an invisible level (within a tolerable range), and furthermore, if the contact angle α1 of the treatment liquid and the contact angle α2 of the ink is 70° or greater, then virtually no bleeding occurs. The treatment liquid and the ink having a contact angle of 20° shown in FIG. 8 are the properties of generally used treatment liquid and ink.

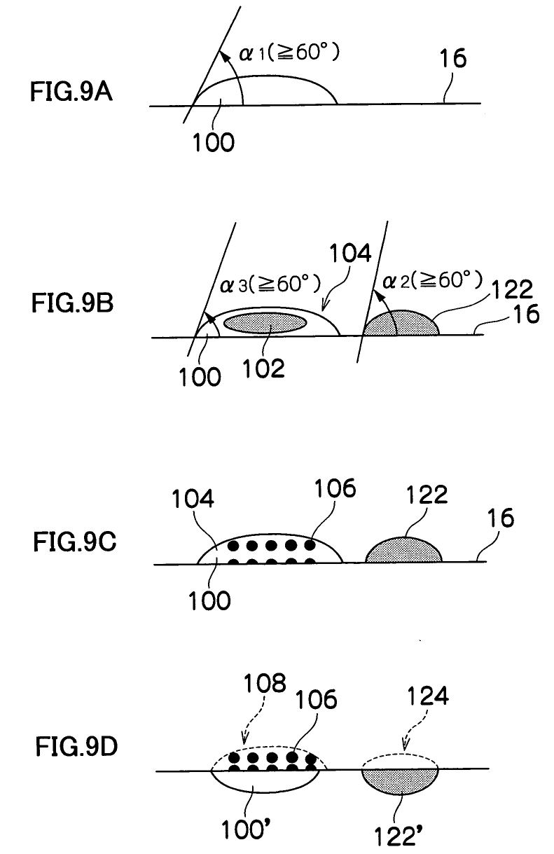

On the basis of the experimental results described above, in the inkjet recording apparatus 10 of the present embodiment, the properties of the treatment liquid and the ink are specified in such a manner that the contact angle α1 of the treatment liquid, the contact angle α2 of the ink and the contact angle α3 of the mixed liquid of the treatment liquid and the ink are each not less than 60°. FIGS. 9A to 9D show the state transitions of the treatment liquid 100, the ink 102 and the mixed liquid 104 of the treatment liquid and the ink, in a case where the contact angle α1 of the treatment liquid 100, the contact angle α2 of the ink 102, and the contact angle α3 of the mixed liquid 104 of the treatment liquid and the ink, each satisfy the condition of being not less than 60°.

As shown in FIG. 9A, when the treatment liquid 100 having a contact angle not less than 60° lands on the recording medium 16, then the speed of permeation of the treatment liquid into the recording medium 16 is slowed in comparison with a case where the contact angle α1 is less than 60°, and hence the amount of treatment liquid which permeates into the recording medium 16 (the permeation volume) can be reduced.

In other words, it is possible to cause a prescribed volume of treatment liquid 100 (the volume required in order to react with the ejected droplets of ink) to be remaining on the recording medium 16, when the ink lands as shown in FIG. 9B, and therefore, it is possible a reliable reaction of the treatment liquid 100 with the ink 102 deposited onto same. FIG. 9C shows a state where the treatment liquid 100 and the ink 102 have reacted together and the ink coloring material 106 has aggregated. Furthermore, it is possible to reduce the amount of unreacted treatment liquid (treatment liquid solvent) and the amount of uncreated ink (ink solvent) produced, and therefore, the amount of unreacted treatment liquid and unreacted ink permeating into the recording medium 16 can be reduced and a desirable dot 108 (indicated by the dotted line) which does not cause bleeding is formed on the recording medium 16. The reference numeral 100′ shown in FIG. 9D indicates the solvents (the solvent of the treatment liquid and the solvent of the ink) which has permeated into the recording medium 16. In a mode where a plurality of heads are provided, then the amount of treatment liquid deposited is settled with reference to the landing time of the ink ejected from the last head (in the composition of the inkjet recording apparatus 10 shown in FIG. 1, the landing time of the Y ink).

Furthermore, in the inkjet recording apparatus 10, the ink properties are specified in such a manner that the contact angle α2 of the ink with respect to the recording medium 16 is not less than 60°. More specifically, as shown in FIG. 9B, if the ink 122 is deposited onto a region where the treatment liquid 100 has not been deposited, due to non-uniform coating, or the like, and if the contact angle α2 of the ink 122 is less than 60°, then bleeding occurs in the dots formed by the ink 122 (see FIG. 8). Consequently, by setting the contact angle of the ink 122 (the contact angle of the ink 122 with respect to the recording medium 16) α2 to be not less than 60°, then the speed of permeation of the ink 122 with respect to the recording medium 16 is slowed in comparison with a case where the contact angle is less than 60°. Therefore, the permeation of the ink 122 into the recording medium 16 is suppressed, and as shown in FIG. 9D, bleeding is reduced in the dot 124 (indicated by the dotted line) formed by the ink 122. The reference numeral 122′ in FIG. 9D indicates the ink (ink solvent) which has permeated into the recording medium 16.

Moreover, in the inkjet recording apparatus 10 in the present embodiment, the properties of the treatment liquid 100 and the properties of the ink 102 are specified in such a manner that the contact angle α3 of the mixed liquid 104 of the treatment liquid 100 and the ink 102, with respect to the recording medium 16 within one second, is not less than 60°.

In general, when two liquids having different contact angles mix together, the contact angle of the mixed liquid takes an intermediate value between the contact angles of the respective liquids (for example, the average value thereof), and therefore, if ink having a contact angle α2 of less than 60° is deposited onto treatment liquid having a contact angle α1 of 60° or greater, then it is possible that the contact angle α3 of the mixed liquid of the treatment liquid and the ink may be less than 60°.

If the contact angle α3 of the mixed liquid 104 is less than 60°, then the permeation of the mixed liquid 104 progresses simultaneously with the reaction between the treatment liquid 100 and the ink 102, and there is a risk that it may be insufficient to suppress bleeding of the ink. Consequently, by setting the contact angle α3 of the mixed liquid 104 to be not less than 60°, it is possible to slow the speed of permeation of the mixed liquid 104 during the progress of the reaction between the treatment liquid 100 and the ink 102, compared to a case where the contact angle α3 of the mixed liquid is less than 60°. As shown in FIG. 9C, the treatment liquid 100 and the ink 102 react together efficiently, thereby causing the coloring material 106 in the ink to become insoluble, and hence suppressing the permeation of the mixed liquid 104 into the recording medium 16. Therefore, as shown in FIG. 9D, a desirable dot 108 is formed, in which coloring material 106 of a high density which produces little bleeding is fixed into the recording medium 16.

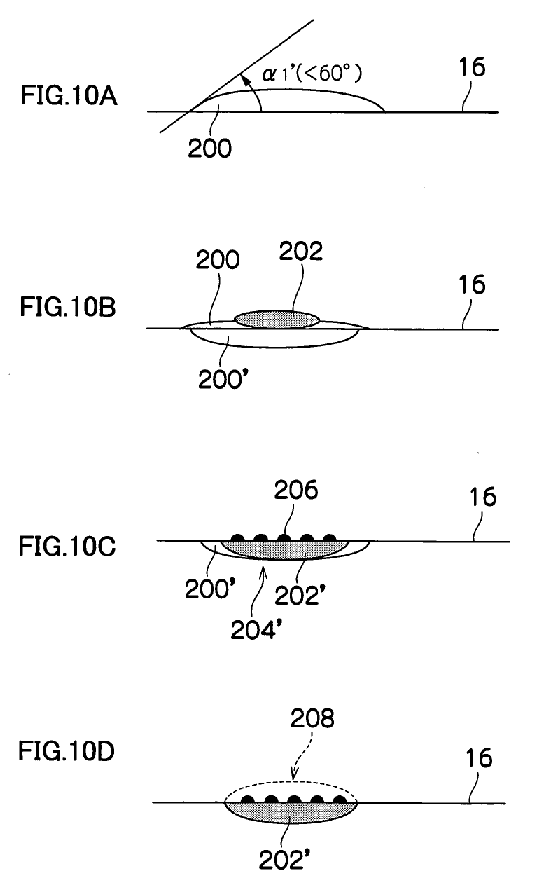

Here, the state transitions of a treatment liquid 200, an ink 202, and a mixed liquid 204 of the treatment liquid 200 and the ink 202 are described with reference to FIGS. 10A to 10D, in respect of a case where the treatment liquid 200 having a contact angle α1′ of less than 60° is used. The contact angle (α2′, not shown in FIGS. 10A to 10D) of the ink 202 shown in FIG. 10B with respect to the recording medium 16 is not less than 60°.

As shown in FIG. 10A, when the treatment liquid 200 having the-contact angle α1′ of less than 60° lands on the recording medium 16, the speed of permeation increases in comparison with the treatment liquid 100 shown in FIGS. 9A and 9B (having the contact angle α1 not less than 60°), and a greater amount of the treatment liquid 200 permeates into the recording medium 16 during a prescribed time period (for example, one second) from the landing time. Therefore, the amount of treatment liquid 200 remaining on the recording medium 16 at the timing at which the ink 202 shown in FIG. 10B lands on the treatment liquid 200 is reduced, in comparison with the state shown in FIG. 9C. The reference numeral 200′ shown in FIGS. 10B and 10C indicates the treatment liquid that has permeated into the recording medium 16.

Consequently, as shown in FIG. 10C, the volume of coloring material 206 fixed onto the recording medium 16 is smaller than the volume of coloring material 106 shown in FIG. 9C, and the dot 208 thus formed has lower density than in FIG. 9D, and hence a dot having the desired density cannot be obtained. Moreover, as shown in FIGS. 10C and 10D, bleeding occurs due to the permeation of treatment liquid 200′ and unreacted ink 202′ (a mixed liquid 204′ of these liquids) into the recording medium 16, and hence the dot 208 spreads to a greater extent than the prescribed size.

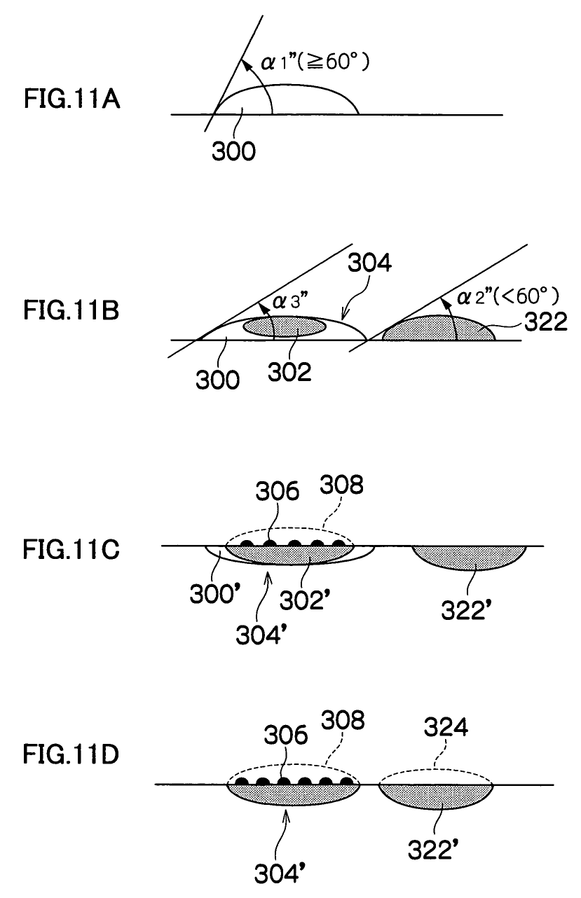

FIGS. 11A to 11D describe the state transitions of a treatment liquid 300, an ink 302, and a mixed liquid 304 of the treatment liquid 300 and the ink 302, in respect of a case where the ink 302 (322) having a contact angle α2″ of less than 60° is used. The contact angle α1″ of the treatment liquid 300 shown in FIGS. 11A and 11B with respect to the recording medium 16 is not less than 60°.

FIG. 11A shows the treatment liquid 300 deposited onto the recording medium 16. The contact angle α1″ of the treatment liquid 300 is not less than 60°, and the amount of the treatment liquid 300 that permeates into the recording medium 16 is extremely small. When the ink 302 having the contact angle α2″ of less than 60° is deposited onto the treatment liquid 300 (see FIG. 11B), then if the contact angle α3″ of the mixed liquid 304 of the treatment liquid 300 and the ink 302 is less than 60°, the reaction between the treatment liquid 300 and the ink 302 proceeds simultaneously with the permeation of the mixed liquid 304 into the medium. Consequently, the amount of coloring material 306 fixed on the recording medium 16 is small compared to the amount of coloring material 106 shown in FIG. 8C, and the dot 308 formed in this manner has a reduced density compared to FIG. 8D. Furthermore, as indicated by the reference numeral 304′ shown in FIGS. 11C and 11D, bleeding occurs due to permeation of the mixed liquid 304 into the recording medium 16, and hence the dot 308 spreads to a greater extent than the prescribed size. The mixed liquid 304′ that permeates into the recording medium 16 includes unreacted treatment liquid 300′ and unreacted ink 302′.

Moreover, when the ink 322 having the contact angle α2″ of less than 60° lands on a region where the treatment liquid 300 has not been deposited (see FIG. 11B), then the amount of permeated ink 322 becomes greater than the state shown in FIG. 9C, and bleeding occurs in the dot 324 shown in FIG. 11D. The reference numeral 322′ shown in FIGS. 11C and 11D indicates the ink that permeates into the recording medium 16.

Description of Surface Tension

Next, the surface tension of the treatment liquid and the ink used in the inkjet recording apparatus 10 is described. In the present inkjet recording apparatus 10, the relationship between the surface tension Ts of the treatment liquid and the surface tension Ti of the ink is Ts<Ti. When treatment liquid and ink having a relationship of this kind is used, then the treatment liquid readily covers the surface of the ink deposited on the treatment liquid, the reaction in the region where the treatment liquid and the ink make contact is promoted, and spreading of the ink can be suppressed. Furthermore, when the reaction of the treatment liquid and the ink is promoted, the permeation of the solvents into the recording medium 16 is suppressed (the permeated volume is reduced) and the level of cockling occurring in the recording medium 16 is reduced.

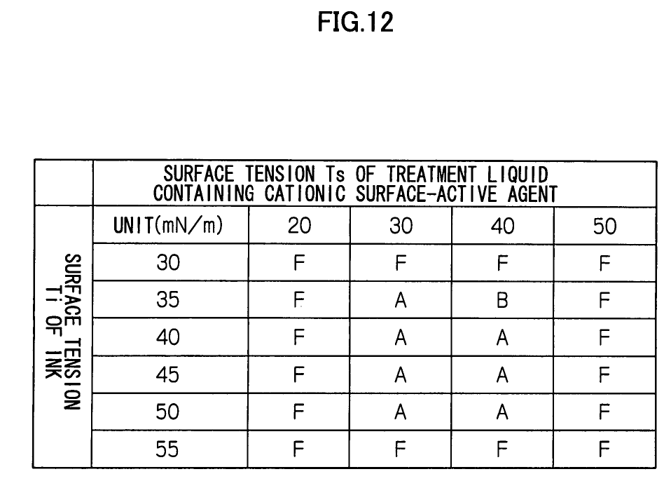

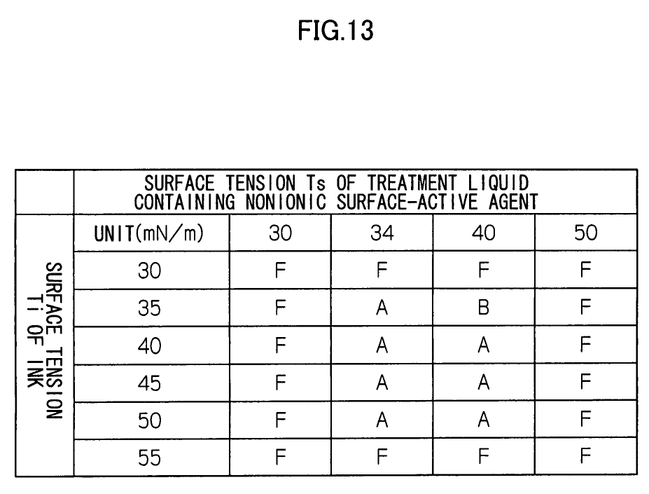

Moreover, the surface tensions of the treatment liquid and the ink are specified in accordance with the type of surface-active agent contained. The range of the surface tension of the treatment liquid and the ink are described here with reference to FIGS. 12 and 13.

FIGS. 12 and 13 are tables showing the visibility of the bleeding of dots formed on a recording medium 16 when the ink and the surface tension are changed. FIG. 12 and FIG. 13 show the results of visual observation of dots, wherein “A” indicates a state where bleeding is not visible in the dots, “B” indicates a state where bleeding occurs in the dots but the bleeding is hardly visible (a state where tolerable bleeding occurs), and “F” indicates a state where bleeding which degrades the image quality occurs in the dots.

Similarly to the dot bleeding observation experiments described with reference to FIG. 8, in the dot bleeding observation experiments for which the results are shown in FIGS. 12 and 13, normal paper (recycled paper) is used as the recording medium, and ink droplets are ejected in a state where treatment liquid has been deposited on the recording medium by means of droplet ejection or application, and the state of the dots one second after landing of the ink is observed visually.

FIG. 12 shows the visibility of bleeding in cases where a cationic surface-active agent is included in the treatment liquid. According to FIG. 12, if the surface tension Ts of the treatment liquid satisfies the condition of 30 mN/m≦Ts≦40 mN/m, and if the surface tension Ti of the ink satisfies the condition of 35 mN/m≦Ti≦50 mN/m, then desirable dots which do not produce visible bleeding are formed on the recording medium 16.

FIG. 13 shows the visibility of bleeding in cases where an anionic surface-active agent is included in the treatment liquid. According to FIG. 13, if the surface tension Ts of the treatment satisfies the condition of 34 mN/m≦Ts≦40 mN/m, and if the surface tension Ti of the ink satisfies the condition of 35 mN/m≦Ti≦50 mN/m, then desirable dots which do not produce visible bleeding are formed on the recording medium 16.

In the inkjet recording apparatus 10 in the present embodiment, an image is formed on the recording medium 16 by using treatment liquid and ink having properties of this kind. More specifically, the ejection from the treatment liquid ejection head 11 is controlled in such a manner that the treatment liquid (treatment liquid A and treatment liquid B) ejected from the treatment liquid ejection head 11 (see FIG. 1) is switched selectively in accordance with the type of the recording medium 16.

For example, the treatment liquid A has properties which satisfy the conditions relating to normal paper, and treatment liquid B has properties which satisfy the conditions relating to special photographic paper. When the treatment liquid A and the treatment liquid B are provided in the inkjet recording apparatus 10, the treatment liquid information for the respective treatment liquids is read in by the treatment liquid information reading unit 92 shown in FIG. 7, and the treatment liquid information is stored in an information storage device (for example, the ROM 75 in FIG. 7, an internal memory card memory (not shown) or external memory).

On the other hand, when the type of recording medium 16 is set by setting the print mode (high-quality mode, high-speed print mode, or the like, or media settings made by the user), then the treatment liquid ejected from the treatment liquid ejection head 11 is selected in accordance with the type of recording medium 16, and the ejection of the treatment liquid ejection head 11 is controlled accordingly. For example, when normal paper is set as the recording medium 16 to be used, then treatment liquid A is ejected from the treatment liquid ejection head 11, and when special photographic paper is set as the recording medium 16 to be used, then the treatment liquid B is ejected from the treatment liquid ejection head 11. A desirable mode is one in which a data table which associates types of recording medium 16 with treatment liquids is stored in the information storage device, or another storage device, in such a manner that the data table can be referenced.

If a recording medium 16 corresponding to neither treatment liquid A nor treatment liquid B is set, then this is reported to the user by means of the control system issuing an alarm or error message. Moreover, a desirable mode is one in which a message is issued to the user prompting the user to change at least one of the recording medium 16 or the treatment liquid. This alarm or error message may be voice-based (or sound-based), or it may be based on text characters, symbols, or the like.

The ink provided in the inkjet recording apparatus 10 has properties whereby the contact angle of the ink with respect to the recording medium 16 having the highest use frequency is not less than 60°, and the contact angle of the mixed liquid of the ink and the treatment liquid used for that recording medium 16 is also not less than 60°. The ink information acquired from the ink information reading unit 90 shown in FIG. 7 is stored in the information storage device and or another storage device, similarly to the treatment liquid information described above.

When a recording medium 16 which is not compatible with this ink (or the mixed liquid of the treatment liquid and the ink) is set, then this fact is reported to the user by issuing an alarm or error message. Moreover, a desirable mode is one in which a message is issued to the user prompting the user to change at least one of the recording medium 16 or the ink.

If a medium having high permeability is used, in such a manner that the presence of a prescribed quantity of treatment liquid cannot be guaranteed on the recording surface when ink droplets are ejected, then there is little sense is using treatment liquid and conversely, any treatment liquid may even aggravate bleeding of the ink. Therefore, in such cases, it is preferable not to use treatment liquid.

In other words, in the case of permeable paper, there is less bleeding of the ink when only ink droplets are ejected, compared to a case where ink droplets are ejected onto treatment liquid. This is because the higher the surface tension, the lower the extent of bleeding, and when ink droplets are ejected onto treatment liquid, the ink tends to bleed as a result of bleeding of the treatment liquid. Consequently, it is possible to suppress bleeding by selecting the type of the treatment liquid, or by selecting whether or not to use treatment liquid, depending on whether or not a permeable paper or a non-permeable paper is used, and thus performing droplet ejection in accordance with the characteristics of the recording medium.

Specific Examples of Treatment Liquid and Ink

In the present embodiment, it is possible to use, as the treatment liquid, an aqueous solution, for example, containing at least the following substances:

| | | |
|---|---|---|
| Sharol DC-902P, manufactured by Dai-Ichi Kogyo Seiyaku Co., Ltd.: | 1 to 20 | wt %; and |
| Olfine E1010, manufactured by Nissin Chemical Industry Co., Ltd.: | 0.05 to 0.1 | wt %, or |
| (as a nonionic surface-active agent) | | |
| Cation G-50, manufactured by Sanyo Chemical Industries, Ltd.: | 0.1 to 0.2 | wt %. |
| (as a cationic surface-active agent) | | |

The following substances can be added to this aqueous solution:

| | | |
|---|---|---|
| glycerol (as a high-boiling-point solvent): | 0 to 30 | wt %; and |
| triethanolamine (as a pH adjuster): | 0 to 10 | wt %. |

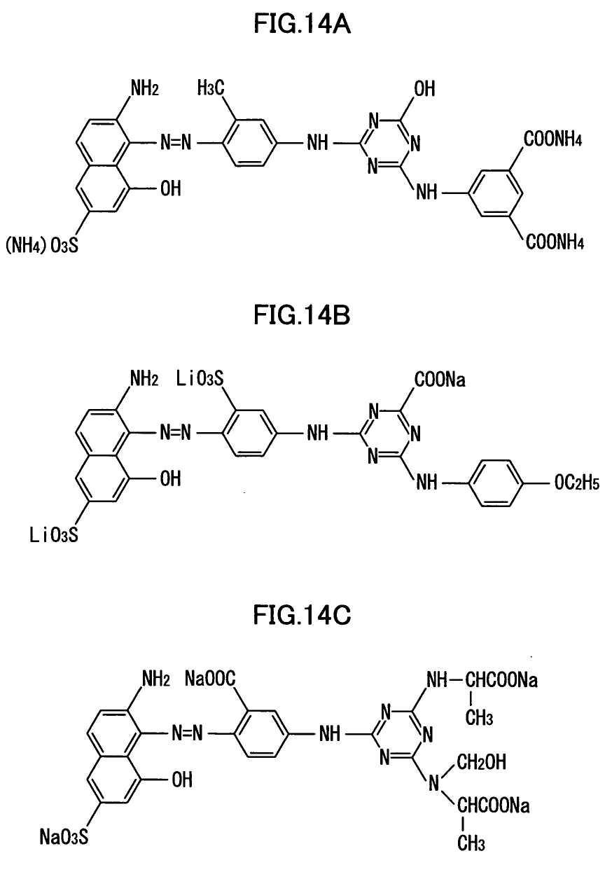

On the other hand, it is possible to use, as an ink containing
a coloring material, an aqueous solution, for example,
containing at least the following substances:

| | | |
|---|---|---|
| an anionic dye compound having the structure shown in | 1 to 30 | wt %; and |
| FIG. 14A, 14B or 14C, for example: | | |
| Olfine E1010, manufactured by Nissin Chemical Industry Co., Ltd. | 0.1 to 10 | wt %. |
| (as a surface-active agent): | | |

The following substances can be added to this aqueous solution:

| | | |
|---|---|---|
| polystyrene sodium sulfonate | 0 to 20 | wt %; |
| glycerol (as a high-boiling-point solvent): | 0 to 30 | wt %; and |
| triethanolamine (as a pH adjuster): | 0 to 10 | wt %. |

In the inkjet recording apparatus 10 having the composition described above, ink droplets are ejected onto a recording medium on which treatment liquid has been deposited, on the basis of image data, thereby insolubilizing the ink, producing an aggregate of the coloring material, and forming an image by means of the aggregate of coloring material. Since the properties of the treatment liquid and the ink are selected in such a manner that the contact angle of the treatment liquid, the contact angle of the ink, and the contact angle of the mixed liquid of ink and treatment liquid, with respect to the recording medium 16, are not less than 60°, then it is possible to make the treatment liquid and the ink react together reliably on the recording medium 16, and hence desirable dots having a prescribed density are formed. Furthermore, by creating a reliable reaction between the treatment liquid and the ink, it is possible to suppress permeation of the mixed liquid of the treatment liquid and the ink into the recording medium 16, and therefore, dots which do not produce any bleeding are formed on the recording medium 16.

Furthermore, since the ink properties are selected in such a manner that the contact angle of the ink with respect to the recording medium 16 is not less than 60°, then even if ink alone is deposited onto a region where no treatment liquid has been deposited, the permeation of the ink can still be suppressed and bleeding can be suppressed in the dots formed by ink alone.

### Further Embodiment

One treatment liquid ejection head 11 is disposed upstream of the print unit 12 in the above-described embodiment (see FIG. 1), but in implementing the present invention, the arrangement of the treatment liquid ejection head is not limited to this embodiment, and it is also possible to adopt a composition in which another treatment liquid ejection head is appended at at least one position between the color heads in the print unit 12.

Furthermore, an ejection head based on an inkjet method is used as the device for applying treatment liquid in the above-described embodiment, but instead of or in combination with this, it is also possible to use a device which applies treatment liquid to the recording medium 16 by using an application member, such as a roller, brush, blade, or the like.

The treatment liquid ejection head 11 that ejects two types of treatment liquid is shown in the above-described embodiment, but it is also possible to compose the treatment liquid ejection head 11 from a plurality of heads, or to use a composition in which treatment liquid of three or more types can be ejected selectively. Furthermore, a mode is shown in which one type of ink is provided in the inkjet recording apparatus 10 in the above-described embodiment, but it is also possible to adopt a composition in which a plurality of heads are provided in such a manner that inks of a plurality of types can be ejected selectively.

The inkjet recording apparatus using a page-wide full line type head having a nozzle row of a length corresponding to the entire width of the recording medium is described in the above-described embodiment, but the scope of application of the present invention is not limited to this, and the present invention may also be applied to an inkjet recording apparatus using a shuttle head which performs image recording while moving a short recording head reciprocally.

It should be understood, however, that there is no intention to limit the invention to the specific forms disclosed, but on the contrary, the invention is to cover all modifications, alternate constructions and equivalents falling within the spirit and scope of the invention as expressed in the appended claims.

1. An image forming apparatus, comprising:
a first liquid deposition device which deposits a first liquid onto a recording medium; and
an ejection head which ejects a second liquid onto the first liquid deposited on the recording medium by the first liquid deposition device,
wherein a contact angle of the first liquid with respect to the recording medium is not less than 60°, and a contact angle of a mixed liquid of the first liquid and the second liquid with respect to the recording medium is not less than 60°.

2. The image forming apparatus as defined in claim 1, wherein a contact angle of the second liquid with respect to the recording medium is not less than 60°.

3. The image forming apparatus as defined in claim 1, wherein a surface tension of the first liquid is lower than a surface tension of the second liquid.

4. The image forming apparatus as defined in claim 1, wherein the first liquid contains a cationic surface-active agent, and a surface tension of the first liquid is not less than 30 mN/m and not more than 40 mN/m.

5. The image forming apparatus as defined in claim 1, wherein the first liquid contains a nonionic surface-active agent, and a surface tension of the first liquid is not less than 34 mN/m and not more than 40 mN/m.

6. The image forming apparatus as defined in claim 1, wherein a surface tension of the second liquid is not less than 35 mN/m and not more than 50 mN/m.

7. The image forming apparatus as defined in claim 1, wherein:
the second liquid is an ink containing a coloring material; and
the first liquid is a treatment liquid containing a substance which causes insolubilization and aggregation of the coloring material in the second liquid deposited on the first liquid.

8. An image forming method, comprising:
a first liquid deposition step of depositing a first liquid onto a recording medium; and
a second liquid ejection step of ejecting a second liquid according to image data for printing, from an ejection head onto the first liquid deposited on the recording medium in the first liquid depositing step,
wherein a contact angle of the first liquid with respect to the recording medium is not less than 60°, and a contact angle of a mixed liquid of the first liquid and the second liquid with respect to the recording medium is not less than 60°.
